(19) United States
(12) Patent Application Publication
(10) Pub. No.: US 2012/0260728 A1
(43) Pub. Date: Oct. 18, 2012

(54) FLUID LEVEL SENSOR SYSTEM

(75) Inventors: Rahul Bhattacharyya, Cambridge, MA (US); Christian Floerkemeier, Zurich (CH); Daniel Deavours, Lawrence, KS (US); Sanjay E. Sarma, Lexington, MA (US)

(73) Assignee: Massachusetts Institute of Technology, Cambridge, MA (US)

(21) Appl. No.: 13/426,676

(22) Filed: Mar. 22, 2012

Related U.S. Application Data
(60) Provisional application No. 61/474,909, filed on Apr. 13, 2011.

(51) Int. Cl. G01F 23/284

(52) U.S. Cl. 73/290 V

(57) ABSTRACT

Fluid level sensor. The sensor includes first and second RFID tag antennas disposed in spaced-apart relation on the outside of a container including fluid therein. An RFID reader transmits power to, and receives backscatter power from, the first and second RFID tag antennas. A difference in backscatter power from the first and second tag antennas indicates the presence of fluid behind the second RFID tag antenna. In another aspect, a single RFID tag antenna is disposed on the outside of a container including fluid therein. An RFID reader transmits power over a selected range of frequencies to the tag antenna and receives backscatter power from the tag antenna. The tag response across all frequencies in the selected range indicates no liquid in the container while tag response in only the higher frequencies of the selected range indicates presence of fluid in the container.

This application claims priority to provisional application Ser. No. 61/474,909, filed on Apr. 13, 2011, the contents of which are incorporated herein by reference.

### BACKGROUND OF THE INVENTION

This invention relates to a fluid level sensor system and more particularly to a fluid level sensor system that uses UHF RFID tag antennas.

Fluid level measurements are desirable in many contexts. One fluid level sensor application is monitoring the level of acid in a backup generator battery. Other applications include determining the level of spirits in glass bottles and the level of fuel in plastic containers.

RFID tag antennas form a mature technology for the identification of goods. An RFID reader transmits power that is received by the tag antenna which sends back a signal that is read by the RFID reader.

It is an object of the present invention to use a novel arrangement of a pair of RFID tag antennas to respond to the level of a liquid in a container. Another object of the invention is the use of a single RFID tag sensor to respond to liquid level in a container.

### SUMMARY OF THE INVENTION

The fluid level sensor system according to one aspect of the invention includes first and second RFID tag antennas disposed in a spaced-apart relation on the outside of a container including fluid therein, the first tag antenna located at a position on the container where there is no liquid behind it, and the second tag antenna located at a position where there may be liquid behind it. An RFID reader transmits power to, and receives backscatter power from, the first and second RFID tag antennas, whereby a difference in backscatter power from the first and second tag antennas indicates the presence of fluid behind the second RFID tag antenna. In a preferred embodiment, the tag antennas operate in the UHF frequency range. In an embodiment, the container is a battery casing and the fluid is battery acid. Of course, the present invention can be used to detect the fluid level of any fluid within a container.

The fluid level sensor system according to another aspect of the invention includes an RFID tag antenna disposed on the outside of a container including fluid therein, An RFID reader transmits power over a selected range of frequencies to the tag antenna and receives backscatter power from the tag antenna. The tag is tuned to respond to the reader across all frequencies in the 902-928 MHz band when there is no fluid present behind the tag and tuned to respond to the reader in a small band of approximately 920-928 MHz when the tag does have fluid behind it.

### BRIEF DESCRIPTION OF THE DRAWING

FIG. 1 is an elevation view of the fluid level sensor system according to an embodiment of the invention.

FIG. 2 is a cross-sectional view of the fluid level sensor system embodiment of FIG. 1

FIG. 3 is an elevation view of an embodiment of the sensor system disclosed herein with fluid below the level of one of the sensors.

FIG. 4 is an elevation view of an embodiment of the system disclosed herein with fluid behind the second sensor.

FIG. 5 is a photograph of an experimental setup for an embodiment of the invention disclosed herein.

FIG. 6 is a graph showing a distinct difference between backscatter power of a reference and a sensor tag.

FIG. 7 is a Smith Chart showing bandwidths when water is present and absent in a container.

FIG. 8 is a graph of fractional channel contribution versus frequency for an empty glass and a full glass.

### DESCRIPTION OF THE PREFERRED EMBODIMENT

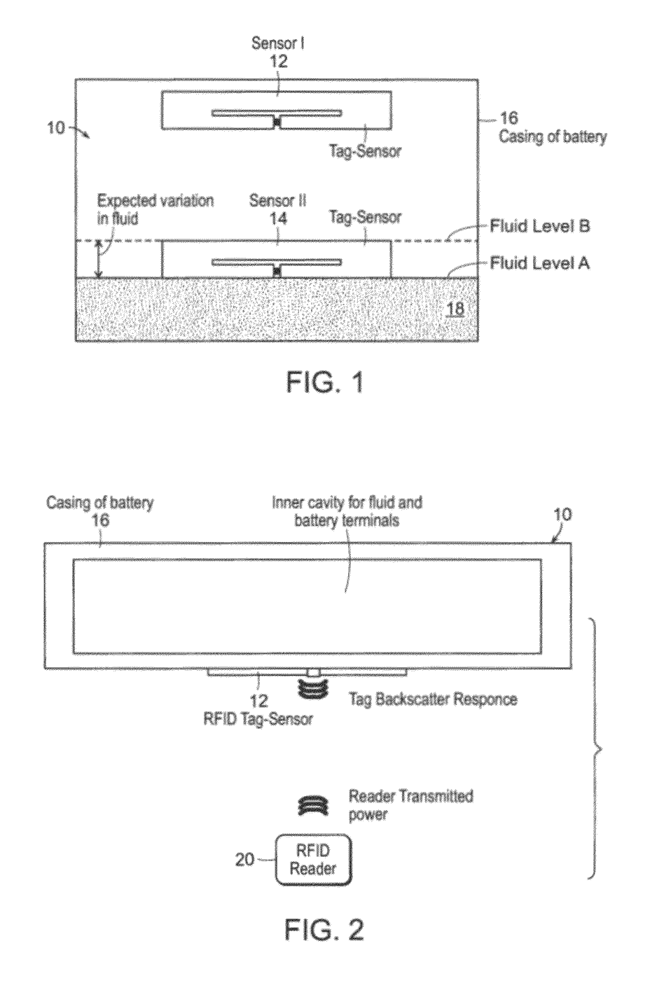

With reference first to FIGS. 1 and 2, a sensor system 10 includes a first tag antenna 12 and a second tag antenna 14. The tag antennas 12 and 14 are custom designed UHF RFID sensors.

The tag antennas 12 and 14 are applied to an outer surface of a container such as a battery casing 16. Within the casing 16 there is battery acid 18 that can have levels denoted by fluid level A and fluid level B in the figure.

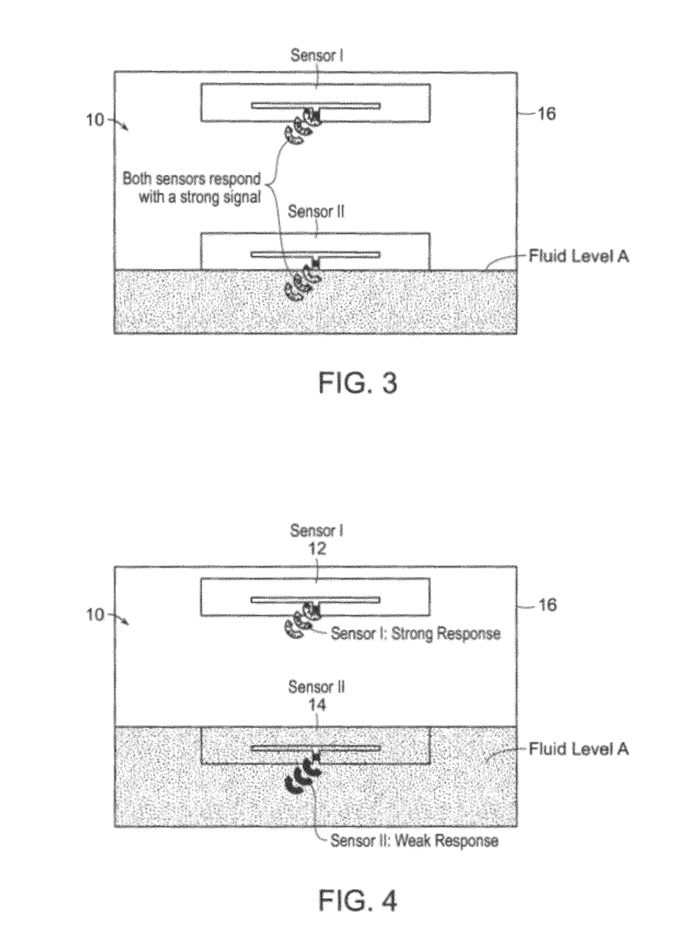

As can he seen in FIG. 1, the fluid level of the acid 18 is below the level of the tag antenna 14. As shown in FIG. 2, an RFID reader 20 transmits power to the RFID tag sensor 12, which produces a backscatter response. As shown in FIG. 3, because fluid in the casing 16 is below the level of the sensor 14, there is no fluid behind either sensor 12 or 14.

The inventors have determined that the backscatter power signal strength from a tag antenna sensor depends on whether or not there is fluid behind the sensor. In particular, the backscatter power level from a sensor behind which there is fluid will be less than from a sensor behind which there is no fluid.

With reference now to FIG. 4, one sees that the fluid level in the casing 16 is above the level of the sensor 14. Thus, the backscatter signal from the sensor 12 will he much stronger than the backscatter power from the tag antenna 14. The large difference in received backscatter power indicates the presence of fluid behind the tag antenna 14.

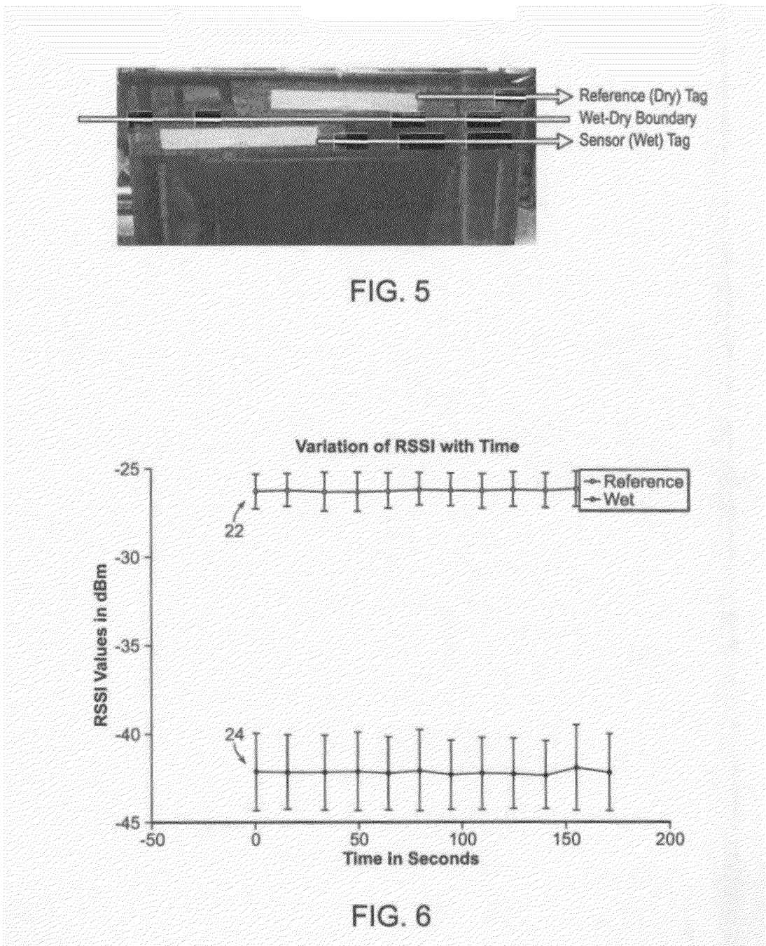

FIG. 5 shows an experimental setup of an embodiment of this aspect of the invention, including two sensors. FIG. 6 shows the backscatter power from the sensor behind which there is no fluid as shown by the curve 22, as compared with the much lower power from the sensor behind which there is fluid as shown by the curve 24. The large difference in backscatter power indicates that there is fluid behind the sensor 14.

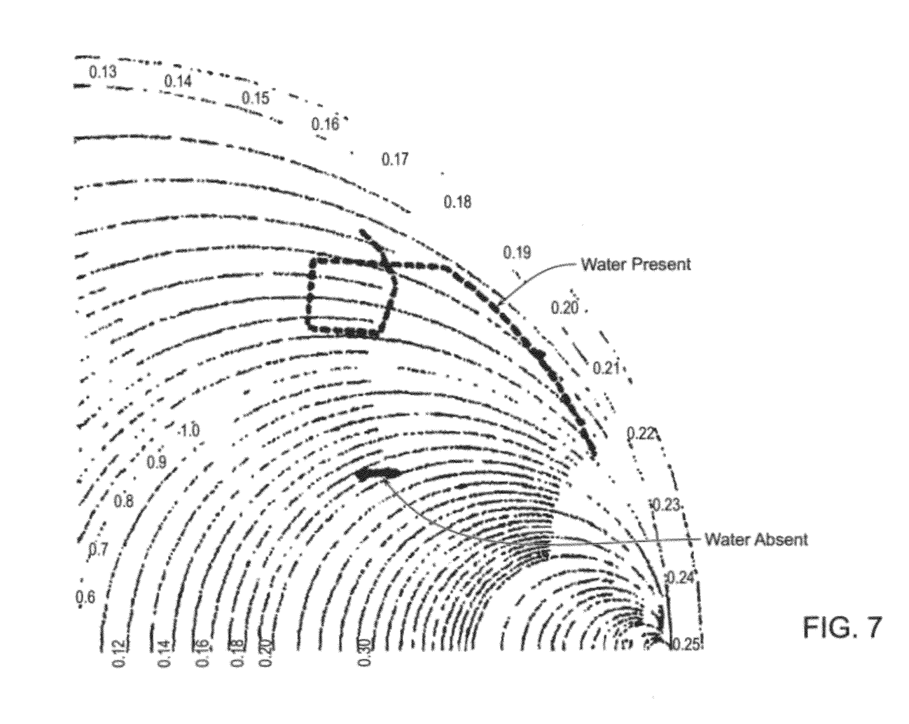

In another aspect, the invention uses a single UHF RED tag for fluid level detection. The inventors have determined that when water is present in a container on the outside of which is located an RFID tag, the tag has a much narrower bandwidth and is better tuned to respond to the reader at frequencies in the 920-928 MHz hand. As can be seen in the Smith Chart of FIG. 7 the tag has a much narrower bandwidth when water is present than when water is absent. For example, when a glass is dry the tag antenna is much more broadband and the sensor responds to the reader in all frequencies in the 902-928 MHz band,

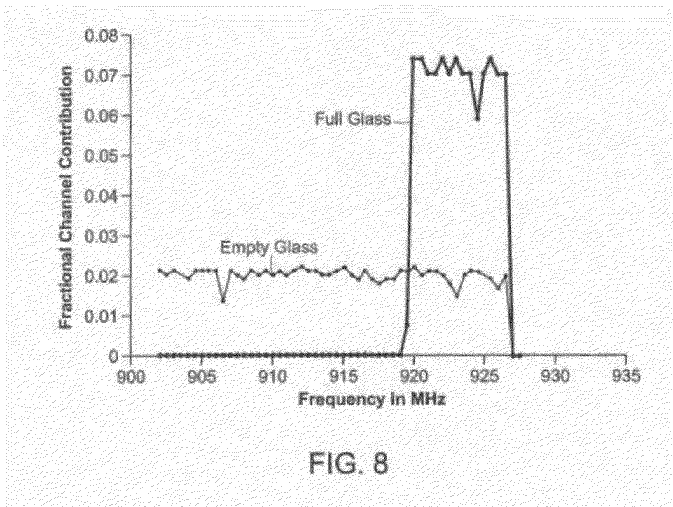

With reference now to FIG. 8, one can see that for an empty glass, the tag does respond to the reader at all frequencies in the 902-928 MHz band. In contrast, for a full glass, the tag does respond in a narrow hand of approximately 920-928 MHz. Thus, the frequency sweep determines whether the container is full or empty. The result in FIG. 8 was performed at a reader transmitted power level of the threshold plus 1.5 dBm. Here the threshold power, for a specific tag reader separation, may be defined as the minimum power that needs to be supplied by the reader in order to just detect the tag.

It is recognized that modifications and variations of the invention disclosed herein will be apparent to those of ordinary skill in the art and it is intended that all such modifications and variations be included within the scope of the appended claims.

What is claimed is:

1. Fluid level sensor system comprising:
first and second RFID tag antennas disposed in spaced-apart relation on the outside of a container including fluid therein, the first tag antenna located at a position on the container where there is no liquid behind it, and the second tag antenna located at a position where there may be liquid behind it; and
an RFID reader for transmitting power to, and receiving backscatter power from, the first and second RFID tag antennas, whereby a difference in backscatter power from the first and second tag antennas indicates the presence of fluid behind the second RFID tag antenna.

2. The system of claim 1 wherein the tag antennas are UHF tag antennas.

3. The system of claim 1 wherein the container is a battery casing.

4. The system of claim 3 wherein the fluid is battery acid.

5. Fluid level sensor system comprising:
an RFID tag antenna disposed on the outside of a container that may contain fluid therein; and
an RFID reader for transmitting power over a selected range of frequencies to the tag antenna and for receiving backscatter power from the tag antenna, whereby when the reader transmitted power is set to threshold plus 1.5 dBm, the tag antenna responds to the reader across all frequencies in the selected range when the container is empty and the tag antenna responds to the reader at only higher frequencies in the selected range when the container is full.

6. The system of claim 5 wherein the selected frequency range is approximately 902-928 MHz.
